(19) United States
(12) Patent Application Publication
(10) Pub. No.: US 2025/0321593 A1
(43) Pub. Date: Oct. 16, 2025

(54) SYSTEM AND METHOD FOR ENHANCED AIRPORT GROUND OPERATIONS

(71) Applicant: Airtrek Robotics Inc, Covington, KY (US)

(72) Inventors: Kyoochul Lee, Cincinnati, OH (US); Huzefa Dossaji, Cincinnati, OH (US); Jonathan Taylor, Loveland, OH (US); David Ladnier, Versailles, KY (US)

(73) Assignee: Airtrek Robotics Inc, Covington, KY (US)

(21) Appl. No.: 19/014,134

(22) Filed: Jan. 8, 2025

Related U.S. Application Data
(60) Provisional application No. 63/618,580, filed on Jan. 8, 2024.

(51) Int. Cl. G05D 1/648; G05D 1/622; G05D 1/689; G05D 105/10; G05D 105/80; G05D 107/13

(52) U.S. Cl. CPC G05D 1/648; G05D 1/622; G05D 1/689; G05D 2105/10; G05D 2105/80; G05D 2107/13

(57) ABSTRACT

Provided are a method and apparatus for inspecting an aircraft located on a ground surface. The apparatus includes a mobility system that transports the apparatus over the ground surface, and sensor circuitry supported by the mobility system. The sensor circuitry includes a proximity sensor that captures proximity data indicative of a presence of the aircraft adjacent to the apparatus, and a damage sensor that captures damage data in response to inspecting a portion of the aircraft for potential damage. A computing system executes computer-executable instructions to detect the presence of the aircraft based on the proximity data, and the potential damage to the aircraft based on the damage data. An indication system issues an alert in response to the potential damage being detected, and a transmitter transmits data indicative of the potential damage to a remote terminal for inclusion in a database entry specific to the aircraft.

### CROSS-REFERENCE TO RELATED APPLICATIONS

This application claims the benefit of U.S. Provisional Application No. 63/618,580, filed Jan. 8, 2024, which is incorporated in its entirety herein by reference.

### BACKGROUND OF THE INVENTION

### 1. Field of the Invention

This application relates generally to a method and apparatus for improving ground operations at an airport and, more specifically, to a robotic system and method for the inspection of an aircraft and/or an airfield, and/or the coordination of ground support assets at an airport.

### 2. Description of Related Art

Ground operations at commercial airports involve coordinated services and activities that occur on the ground to support the arrival, departure, maintenance, and overall operations of aircraft. When performed in a timely manner, ground operations ensure that aircraft are properly handled upon landing, safely managed during the turnaround process, and are ready for takeoff at the next scheduled departure time.

The turnaround process is performed to prepare the aircraft for its next departure. Among the activities performed as part of the turnaround process are: i) aircraft inspection, ii) clearing the surrounding area of the airfield from debris that could potentially be taken in by a jet engine, and iii) other services aimed at preparing the aircraft and the surrounding environment that is used for aircraft departure. Typically, aircraft inspection is performed by the pilot or another member of the flight crew doing a visual inspection while walking around the aircraft. At the same time, the person walking around the aircraft may glance at the ground for any debris on the airfield. However, such inspections are limited in effectiveness due to the inspector's knowledge of the aircraft's construction, human error, and possibly environmental factors such as weather or darkness that may interfere with the inspector's visual inspection. Also, the inspector's attention may be split between observing the aircraft, scanning the surface of the airfield, and other duties involved in preparing the aircraft for departure.

A variety of personnel and vehicles are involved in the turnaround process between the aircraft's arrival and departure. Fuel trucks, baggage trains, water tankers, fuel evacuation vehicles, maintenance vehicles, catering trucks, de-icing rigs, airfield sweepers, pushback tugs, etc. are operated by airport employees and/or contractors to render their respective services. Additional airport personnel may be required to perform further support services independently of a vehicle. Each person requires security clearance to access the airfield, which is generally represented by credentials such as a badge worn by those workers while in the performance of their duties. However, current security measures rely heavily on human vigilance, which can be inconsistent.

Coordinating all of the resources used in performing ground operations during the turnaround process allows some of those resources to be shared amongst gates at the airport, to service different aircraft on the ground at different times. Traditional coordination measures are generally reactive and have relied heavily on radio communications to direct vehicles and personnel to the gates where an aircraft is present and awaiting turnaround services. These operations must be diligently coordinated and performed with seamless teamwork between airlines, ground service providers, security agencies, and air traffic controllers to ensure safe and timely operations.

### BRIEF SUMMARY OF THE INVENTION

According to one aspect, the subject application involves an apparatus for inspecting an aircraft located on a ground surface. According to an illustrative embodiment, the apparatus includes a mobility system that is operable to transport the apparatus over the ground surface adjacent to the aircraft. Sensor circuitry supported by the mobility system includes: (i) a proximity sensor that captures proximity data indicative of a presence of the aircraft adjacent to the apparatus, and (ii) a damage sensor that captures damage data in response to inspecting a portion of the aircraft for potential damage. A computing system including one or a plurality of computer processors executes computer-executable instructions to detect: (i) the presence of the aircraft based on the proximity data, and (ii) the potential damage to the aircraft based on the damage data. An indication system issues an alert in response to the potential damage being detected by the computing system, and a transmitter transmits data indicative of the potential damage to a remote terminal for inclusion in a log entry specific to the aircraft within an aircraft database.

According to some embodiments, the computing system can be programmed with computer-executable instructions that, when executed, control operation of the mobility system to transport the apparatus along a defined route on the ground surface based on a flight schedule for the airport. A receiver can be provided to receive maintenance data stored by the aircraft database concerning a previous repair that was performed on a repaired portion of the aircraft. The computing system can execute the computer-executable instructions to control operation of the mobility system to transport the apparatus to a location along the defined route suitable for inspection of the repaired portion of the aircraft. According to some embodiments, the computing system can control operation of the mobility system and influences transportation of the apparatus along the defined route based on the proximity data.

According to some embodiments, the damage sensor can include a camera system that captures the damage data by capturing an image of the portion of the aircraft, and the computing system can detect the potential damage based on a change of content appearing in the image relative to content appearing in a plurality of historical images captured of at least one of: (i) the portion of the aircraft, and (ii) the portion of a plurality of different aircraft.

According to some embodiments, the damage sensor can include a camera system that captures the damage data by capturing an image of the portion of the aircraft, and the computing system detects the potential damage based on a comparison of content appearing in the image to content appearing in a reference image specific to the aircraft.

According to some embodiments, the damage sensor can include a camera system that captures: (i) the damage data by capturing an image of the portion of the aircraft, and (ii) hazard data indicative of an environmental hazard present at the ground surface.

According to some embodiments, a debris collector can be provided to collect foreign objects present on the ground surface, wherein the debris collector comprises at least one of: a magnet, a vacuum, and a broom.

According to some embodiments, the indication system can include a display device that displays, in response to the potential damage being detected, at least one of: (i) a description of the potential damage, (ii) a location of the potential damage, and (iii) remedial action that can be taken to address the potential damage.

According to some embodiments, the transmitter can communicate with a portable communication device carried by a ground crew member, and the data indicative of the potential damage transmitted by the transmitter causes the portable communication device to display information related to the potential damage.

According to another aspect, the subject application involves a non-transitory computer-readable medium storing computer-executable instructions that, when executed by a processing unit of a computer, cause the computer to operate a mobility system to transport an inspection apparatus over a ground surface adjacent to an aircraft at rest on the ground surface. Sensor circuitry supported by the mobility system can be activated to capture: (i) proximity data indicative of a proximity of the aircraft to a proximity sensor provided to the inspection apparatus, and (ii) damage data in response to inspecting a portion of the aircraft for potential damage using a damage sensor provided to the inspection apparatus. The presence of the aircraft based on the proximity data, and the potential damage to the aircraft based on the damage data from the damage sensor are detected, and an alert is issued using an indication system in response to detecting the potential damage. Data indicative of the potential damage can also optionally be transmitted to a remote terminal to be included in a log entry specific to the aircraft within an aircraft database.

According to another aspect, the subject application involves an apparatus for searching for foreign-object debris on an airfield of an airport, the airfield comprising a runway where an aircraft takes off and lands, and an apron where the aircraft parks between landing and taking off. According to some embodiments, the apparatus includes a receiver that receives a command from an airport control center to conduct a search for foreign-object debris on a region of the airfield comprising at least one of the apron and the runway. The command identifies the region of the airfield to be searched for the foreign-object debris. A navigation system: (i) generates a route to be traveled by the apparatus to reach the region of the airfield identified in the command received by the receiver, and (ii) generates a coverage plan that defines a travel path to be traveled by the apparatus over the region of the airfield to conduct the search for the foreign-object debris. A mobility system is operable to transport the apparatus along the route to the region of the airfield, and to transport the apparatus along the travel path during a search for the foreign-object debris. Sensor circuitry can include one, or a plurality of sensors that detect: (i) an obstacle on the airfield encountered by the apparatus, and (ii) the foreign-object debris on airfield 12. A computing system comprising one or a plurality of computer processors executes computer-executable instructions to control operation of the mobility system to avoid a collision between the apparatus and the obstacle on the airfield detected by the sensor circuitry. A debris collector collects the foreign-object debris detected on the airfield by the sensor circuitry.

According to another aspect, the subject application involves an apparatus for searching for foreign-object debris on an airfield of an airport, the airfield comprising a runway where an aircraft takes off and lands, and an apron where the aircraft parks between landing and taking off. According to some embodiments, the apparatus includes a receiver that receives a command to conduct a search for foreign-object debris on a region of the airfield. A navigation system: (i) generates a route to be traveled by the apparatus to reach the region of the airfield, and (ii) generates a coverage plan that defines a travel path to be traveled by the apparatus over the region of the airfield to conduct the search for the foreign-object debris. A mobility system is operable to transport the apparatus along the route to the region of the airfield, and to transport the apparatus along the travel path during a search for the foreign-object debris. Sensor circuitry can include one, or a plurality of sensors that detect: (i) an obstacle on the airfield encountered by the apparatus, and (ii) the foreign-object debris on the airfield. A computing system including one or a plurality of computer processors executes computer-executable instructions to control operation of the mobility system to avoid a collision between the apparatus and the obstacle on the airfield detected by the sensor circuitry. A display device is controlled by the computing system to emit a visible signal in response to detection of the foreign-object debris by the sensor circuitry.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF SEVERAL VIEWS OF THE DRAWING

The invention may take physical form in certain parts and arrangement of parts, embodiments of which will be described in detail in this specification and illustrated in the accompanying drawings which form a part hereof and wherein:

FIG. 1 shows an illustrative embodiment of an airport including an airfield used by aircraft arriving at, and departing from the airport;

FIG. 2A shows an illustrative embodiment of a robot that can autonomously participate in a turnaround process performed on an aircraft and/or perform one or more other ground operations at an airport;

FIG. 2B shows another illustrative embodiment of a robot that can autonomously participate in a turnaround process performed on an aircraft and/or perform one or more other ground operations at an airport;

FIG. 3A is a flow diagram graphically depicting a method of inspecting an aircraft with an autonomous robot in accordance with some embodiments of the present disclosure;

FIG. 3B is a flow diagram graphically depicting a method of inspecting a marking on an airfield with an autonomous robot in accordance with some embodiments of the present disclosure;

FIG. 4 is a perspective view of an autonomous robot in accordance with some embodiments of the present disclosure in a state of use inspecting a portion of an aircraft;

FIG. 5A is a reference image of a portion of an aircraft known to be free of damage, compared by a computing system to a captured image of the same portion of an aircraft in FIG. 5B to identify potential damage to the portion of the aircraft appearing in the captured image;

FIG. 5B is a captured image of a portion of an aircraft to be compared to the reference image in FIG. 5A to identify potential damage to the portion of the aircraft appearing in the captured image;

FIG. 6 illustrates a computer-generated, graphical representation of portion of an airfield containing foreign-object debris labeled by a computing system according to some embodiments of the present disclosure; and

FIG. 7 illustrates an embodiment of a computing system configured with the example systems and/or methods disclosed.

### DETAILED DESCRIPTION OF THE INVENTION

Certain terminology is used herein for convenience only and is not to be taken as a limitation on the present invention. Relative language used herein is best understood with reference to the drawings, in which like numerals are used to identify like or similar items. Further, in the drawings, certain features may be shown in somewhat schematic form.

It is also to be noted that the phrase “at least one of”, if used herein, followed by a plurality of members herein means one of the members, or a combination of more than one of the members. For example, the phrase “at least one of a first widget and a second widget” means in the present application: the first widget, the second widget, or the first widget and the second widget. Likewise, “at least one of a first widget, a second widget and a third widget” means in the present application: the first widget, the second widget, the third widget, the first widget and the second widget, the first widget and the third widget, the second widget and the third widget, or the first widget and the second widget and the third widget.

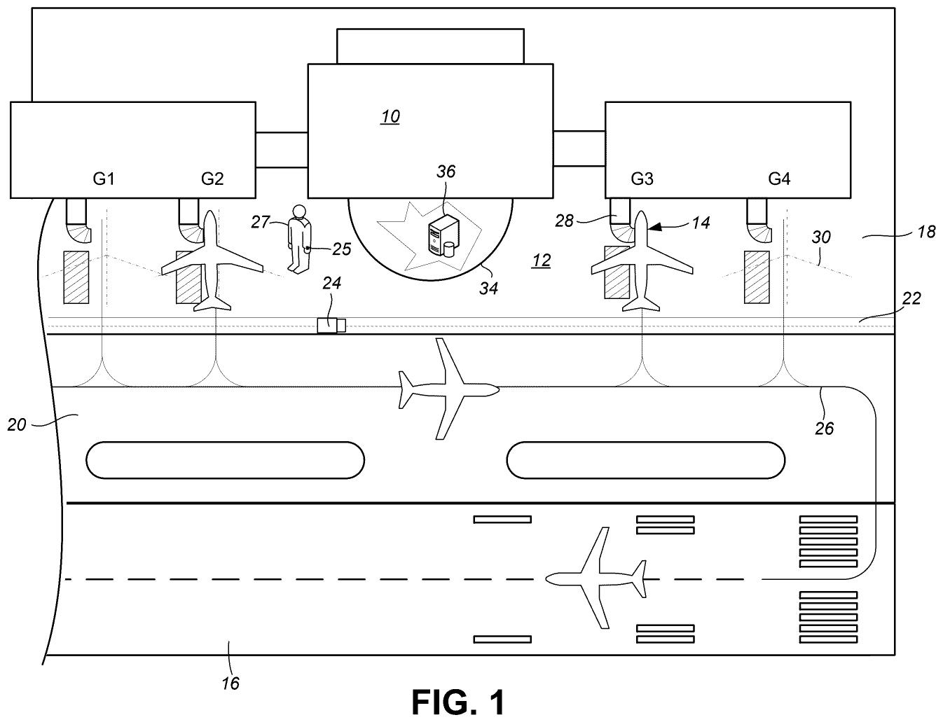

FIG. 1 shows an illustrative embodiment of airport 10 comprising airfield 12 used by aircraft 14 arriving at and departing from airport 10. As shown, airfield 12 includes a paved surface that includes runway 16 along which aircraft 14 can takeoff and land, and apron 18 on which aircraft 14 park during a turnaround process between an aircraft's arrival and departure at airport 10. Taxiway 20 forms an access road for aircraft to travel between apron 18 and runway 16, and service road 22 is designated for use by service vehicles 24 involved in the turnaround process to travel between service locations such as different gates (e.g., between gate G2 and gate G3). Traveling along service road 22 allows service vehicles 24 to substantially avoid taxiway 20 and other parts of apron 18, such as gates G1-G4, to minimize opportunities for collisions with aircraft 14.

At least one, and optionally a plurality or all portions of airfield 12 can include markings that aid in guiding vehicles. For example, taxiway 20 includes taxi lines 26 that aircraft 14 can follow while taxiing between their respective gates G1-G4 on apron 18 and runway 16. Taxi lines 26 can include a region that extends onto apron 18 to guide aircraft 14 to locations on apron 18 where they park and allow passengers to board and deplane aircraft 14 via jet bridge 28. Similarly, taxi lines 26 can extend up to, and optionally onto, runway 16 to guide aircraft 14 to or from runway 16. At least some of the markings applied to the portions of airfield 12 are composed of a reflective material such as a paint or other coating that contains glass beads, metallic flecking or other reflective additive. The reflective nature of such materials improves visibility of the markings to pilots and ground personnel 27 operating vehicles on airfield 12. As described in detail below, one or more of such markings, optionally in addition to or instead of geographical features of airport 10 such as buildings (e.g., jet bridge 28), perimeter fencing, obstacles such as aircraft 14, etc. can be used as reference points by robot 32 described herein. Further, some embodiments of robot 32 are configured to inspect the condition of markings for conditions such as reflectivity degradation and/or excess wear that has compromised the continuity of the markings on airfield 12.

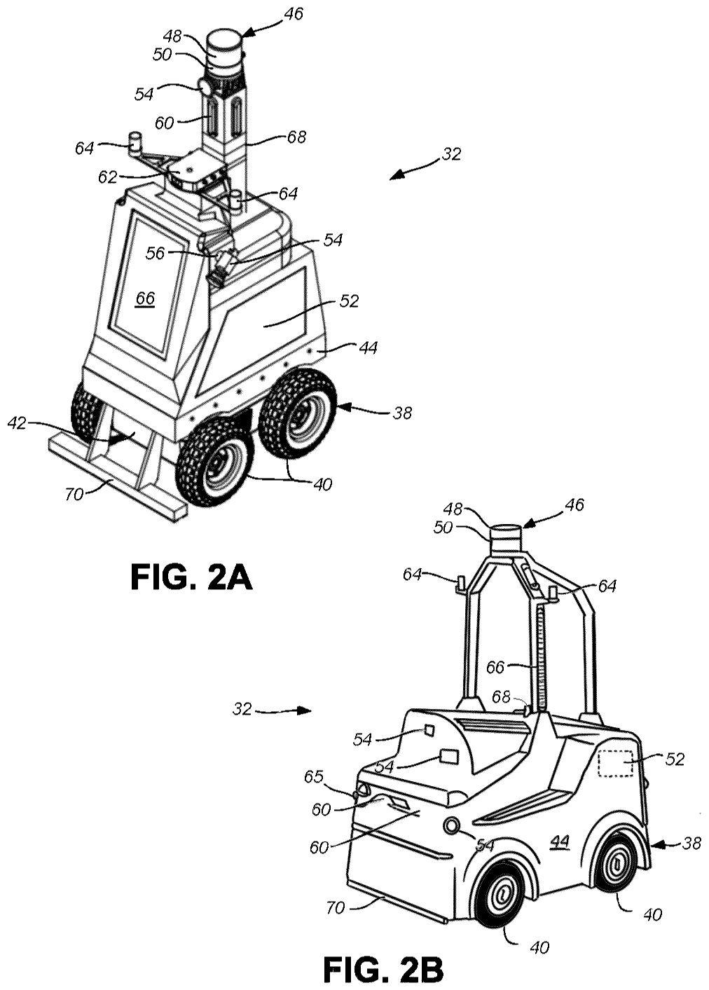

According to some embodiments, at least one of apron 18, taxiway 20, and runway 16 can optionally include guide markers 30. As opposed to markings provided to airfield 12 for guiding aircraft and/or service vehicles 24, guide markers 30 can include any marker, circuit, electric conductor, or other indicator that is optionally specifically-purposed to guide the travel of robot 32, and can be used by robot 32 (FIGS. 2A and 2B) described herein to autonomously travel between locations where robot 32 is to perform any of its functions. Although guide markers 30 are shown in FIG. 1 as being lines or other indicators visible on the surface of airfield 12, guide markers 30 of the present disclosure are not so limited. According to alternate embodiments, guide markers 30 can optionally include electric conductors such as wires and/or circuitry buried beneath the surface of the airfield 12. Such buried guide markers 30 can transmit a signal, generate an electromagnetic field or emit any other type of transmission that robot 32 can detect and follow to a desired location. Yet other embodiments of guide markers 30 can be virtual. For example, virtual guide markers 30 can include waypoints in a positioning system that uses data from navigation satellites in space orbit or from sub-orbital or terrestrial transmitters to triangulate or otherwise determine robot 32's location on airfield 12. Robot 32, with the aid of such positioning systems, can navigate to different waypoints at the appropriate time to perform its functions described herein.

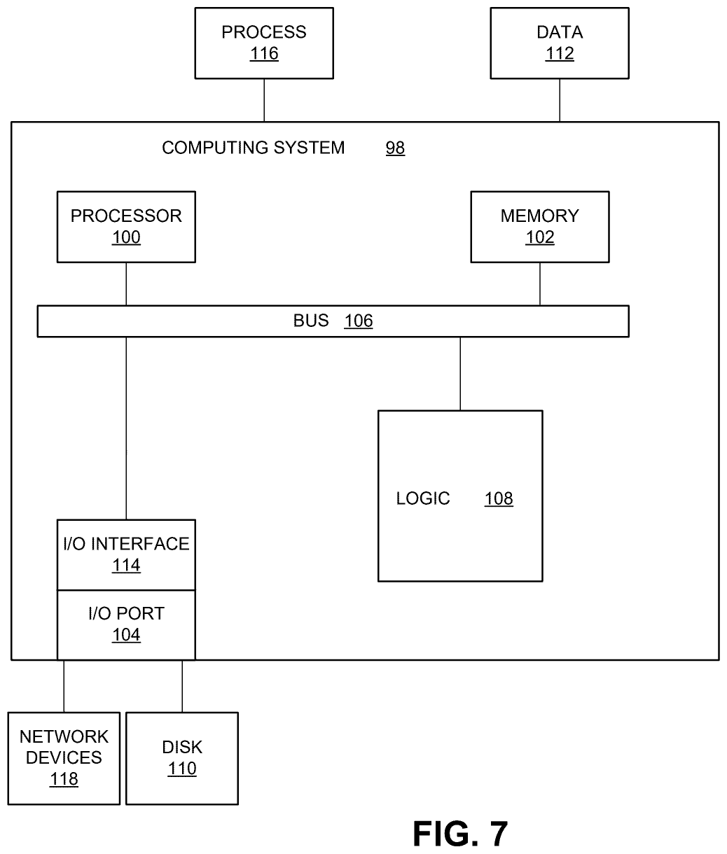

Airport 10 can also include, or at least be in communication with control center 34 that includes computing system 36, such as that described in detail below with reference to FIG. 7. Computing system 36 can include a database server for storing and managing flight schedule information, and an operation server in communication with one or more of robots 32 that perform services on airfield 12 as described herein. Examples of the communications with robot(s) 32 include, but are not limited to: sensor data transmitted from the robots 32, for updating a real-time digital twin of airfield 12 for coordinating ground operations, and distributing content generated as part of the digital twin over a local area network and/or a wide area network to robots 32, service vehicles 24, and/or portable communication devices (e.g., smart watches 25) worn by human ground personnel 27.

FIG. 2A shows an illustrative embodiment of robot 32 that can autonomously participate in the turnaround process of aircraft 14 and/or perform one or more other ground operations. For example, robot 32 can autonomously maneuver over airfield 12 to: i) inspect airfield 12 for objects that could potentially pose a ground hazard to aircraft 14, ii) inspect aircraft 14, iii) conduct a security check, iv) sense information concerning the ambient environment surrounding aircraft 14, v) inspect markings applied to the surface of airfield 12, or v) perform any combination thereof.

According to the embodiment shown in FIG. 2A, robot 32 includes mobility system 38 that is operable to transport robot 32 over the surface of airfield 12. Mobility system 38 can include a plurality of wheels 40, a continuous track system, or any other such device that can be selectively driven by electric motor 42 powered by an onboard battery, internal combustion engine, or the like to transport robot 32 over the surface of airfield 12.

Sensor circuitry can be supported by chassis 44 coupled to mobility system 38. The sensor circuitry can include at least one, and optionally a plurality of types of sensors that detect the presence of at least one of: i) foreign-object debris present on airfield 12 (adjacent to aircraft 14), ii) an oil spill or other fluid puddle (resulting from a fluid spill of some sort); iii) a crack, pothole or other defect in the substantially planar surface of airfield 12; iv) a condition of markings appearing on the surface of airfield 12; v) aircraft 14 surface damage; or vi) unauthorized personnel.

According to an embodiment, the sensor circuitry can include sensor 46 that captures proximity data indicative of the presence of aircraft 14 (and other objects) adjacent to robot 32. For example, sensor 46 can be a light detection and ranging (LiDAR) sensor that includes laser light source 48, photodetector 50 or other light sensor that detects a portion of the laser light that is reflected by an object, and a timer circuit, which can optionally be included as part of the circuitry of computing system 52, such as that described in detail below with reference to FIG. 7, provided to robot 32. A portion of the laser light emitted by the laser light source 48 that strikes an object on the airfield 12 is reflected back to the photodetector 50, and the timer circuit measures the time it takes for that reflected laser light to return to photodetector 50.

When in use adjacent to aircraft 14 parked at gate G3, for example, the LiDAR embodiment of sensor 46 can continuously monitor the surrounding environment of aircraft 14, ranging from the surface of airfield 12 to the bottom of aircraft 14's fuselage. The proximity data captured through monitoring this space can be used by computing system 52 of robot 32 to accurately determine the distance of robot 32 from aircraft 14, and any objects near aircraft 14, as robot 32 navigates about aircraft 14 as described herein. Computing system 52 uses this proximity data to control operation of mobility system 38 to stop or change the travel direction of robot 32, thereby mitigating the possibility of collisions between the moving robot 32, aircraft 14, and other detected objects.

According to some embodiments, the LiDAR or other type of

proximity sensor 46, or a second sensor can constitute part of damage sensor system 58. According to such an embodiment, data collected by the LiDAR or other type of sensor can be used to generate a map of objects on airfield 12 or generate a map of the surface of aircraft 14 as part of the inspection process. Because the LiDAR data represents only the contours of a surface scan, the resulting map is a monochromatic representation of airfield 12 surface, surface of aircraft 14, and objects there between.

According to another embodiment, the sensor circuitry can optionally include at least one, and optionally a plurality of cameras 54 or other image-capture devices forming a portion of airfield 12 inspection or damage sensor system 58. The at least one camera 54 is operable to capture images of portions of aircraft 14 during an inspection. As another example, camera 54 can capture images of foreign-object debris present on airfield 12. By way of example, camera 54 can include a complementary metal-oxide semiconductor (CMOS), charge-coupled device (CCD) or other type of image sensor. According to an illustrative embodiment, camera 54 can optionally be mounted on an adjustable mount 56 controlled by computing system 52 to vary a sight line of camera 54 between the surface of airfield 12 and the underside of aircraft 54's fuselage. According to other embodiments, a plurality of cameras 54 can be provided to robot 52, one or more of which including a fixed sight line aimed at different regions of the space between the surface of airfield 12 and the underside of aircraft 54's fuselage.

Laser light source 48, light 60, or another illumination device can optionally be used in combination with the sensor circuitry described herein to inspect the markings applied to airfield 12. According to some embodiments, laser light source 48 can be directed toward a region of a marking a known distance in front of robot 32. A portion of the sensor circuitry such as photodetector 50 and/or camera 54, for example, can capture a portion of the light reflected by the marking and measure an intensity of the reflected light or another quality indicative of the reflectivity of the marking that was illuminated. By continuously, periodically, or occasionally illumining the marking and measuring a parameter indicative of the reflectivity of the marking while robot 32 is underway, regions of the marking that exhibit little to no reflectivity can be deemed to be damaged.

For example, a segment of marking that exhibits reflectivity approximately equal to (e.g., within ten (10%) percent of) the surrounding surface of airfield 12 can be deemed to be missing. Such a condition may result from repeated exposure of the marking to wheels of aircraft 14 and other vehicles, causing removal of the marking from airfield 12 as a result of wear and tear. In response, computing system 52 can generate an alert that is transmitted by transceiver 68 to computing system 36 or other maintenance system. The alert can include coordinates or other information identifying a location of the damaged portion of the marking, so round personnel 27 or maintenance staff can be dispatched to effectuate repairs to the damaged marking.

According to some embodiments, robot 32 can be configured as required of a testing device to inspect the markings for compliance with state and/or federal laws and regulations governing airport 10 markings. For example, U.S. Federal Aviation Administration (“FAA”) regulations require airfield 12 markings, including runway 16 and taxiway 20 markings, to meet specific retroreflectivity standards tested in accordance with ASTM E1710, promulgated by ASTM International. Retroreflection occurs when a surface returns a large portion of directed light beam back to the light source used to illuminate that surface. Retroreflective materials appear brightest when observed from a vantage point nearest the light source. Retroreflectivity is diminished as a material forming a marking on airfield 12 is degraded by mechanical or chemical damage from the airfield 12 environment. Testing retroreflectivity ensures markings exhibit a consistent level of nighttime visibility when illuminated by aircraft 14 landing lights.

Embodiments of robot 32 can optionally be configured with a light source and light sensor that are positioned in compliance with ASTM E1710, or other law or regulation issued by a governmental or regulatory authority governing inspection of airfield 12 where robot 32 to be used to inspect markings on airfield 12. For such embodiments, a portion of the marking approximately (+10%) thirty (30 m) meters ahead of robot 32 is illuminated by laser light source 48, light 60 or other illumination device, which can be at an elevation of approximately (+10%) sixty-five hundredths (0.65 m) of a meter above airfield 12. Thus, the light emitted toward the marking under inspection has a known angle of incidence. The sensor circuitry such as photodetector 50, camera 54 or other sensor used to measure the light reflected by the marking is maintained at an elevation of approximately one and two tenths (1.2 m) of a meter above airfield 12.

According to alternate embodiments, robot 32 can optionally be configured with components such as a light source and/or light sensor positioned differently than called for by ASTM E1710 or other law or regulation issued by a governmental or regulatory authority. For example, laser light source 48, light 60 or other illumination device, can be at an elevation other than sixty-five hundredths (0.65 m) of a meter above airfield 12 (e.g., more than 10% less than or greater than sixty-five hundredths (0.65 m) of a meter above airfield 12). Similarly, sensor circuitry such as photodetector 50, camera 54 or other sensor used to measure the light reflected by the marking can be maintained by robot 32 at an elevation that is at least 10% less than or greater than one and two tenths (1.2 m) of a meter above airfield 12. Computing system 52 can execute computer-executable instructions that correlates retroreflectivity measured by such a non-conforming robot 32 to predict whether the marking under inspection is compliant with ASTM E1710 or other applicable law or regulation. Accordingly, robot 32 is capable of measuring the retroreflectivity of markings in various different locations where laws and/or regulations may be different. Regardless of the configuration of robot 32, an alert and the location of any portion of the marking requiring repair to maintain the marking in compliance with an applicable law, regulation or other standard can be issued even if a degraded portion of the marking is still compliant. Effectuating a repair prior to falling below a low permissible threshold can help to address marking degradation before the marking falls out of compliance.

In addition to sensor 46, robot 32 can optionally include magnet 70 or other debris clearing device such as a vacuum, rotary brush, or other collection device. Magnet 70, for example, can be a permanent magnet that always exhibits its magnetic properties, an electromagnet that can be selectively activated when passing over a region of airfield 12 to pick up ferromagnetic debris during an inspection, or any other type of magnet that can magnetically attract ferromagnetic debris. Magnet 70 can be coupled to chassis 44, mobility system 38, or any other portion of robot 32 to be suspended adjacent to the surface of airfield 12.

Regardless of the configuration of the at least one camera 54, computing system 52 can control operation of the at least one camera 54 and also control an optional adjustable mount 56, to capture color images of the surface of airfield 12 and the underside (and/or other exposed surfaces) of aircraft 14. Image capture can optionally occur continuously, at intervals, or at predetermined times while robot 32 is stationary or in motion during an inspection. LED light 60 or other suitable light source can be provided to robot 32 and is controlled by computing system 52. LED light 60, for example, illuminates a portion of airfield 12, a portion of aircraft 14, or other object under inspection to allow for color images to be captured by camera(s) 54 even in low-light environments and at night. Computing system 52 can digitally overlay, or otherwise use the captured color images in combination with a map of objects on airfield 12 and/or the surface map of aircraft 14 generated based on the proximity data captured by the LiDAR, for example. This combined use of the color images with a map improves contrast between objects appearing in both the map and the color images, thereby facilitating foreign-object debris detection, environmental understanding for autonomous movement of robot 32, and detection of potential damage to aircraft 14.

According to alternate embodiments, computing system 52 can optionally use the captured color images independently of data captured by the LiDAR to detect foreign-object debris and/or damage to a surface of aircraft 14. For example, camera 54 can capture images of the exposed surface of airfield 14. Computing system 52 can use optical recognition algorithms to detect anomalies, which are deviations from a substantially-planar surface of airfield 14, to sense the presence of potential foreign-object debris on airfield 14. Such objects appearing in images captured by camera 54 can be compared to reference images of known objects that have previously been found, or are commonly found on airfield 14 in a database accessible to computing system 52.

According to some embodiments, computing system 52 can control operation of LED light 60 or other source of light 60 to create a strobe effect, alter a color of light emitted, or otherwise generate a high-visibility alert. The high-visibility alert can be generated while robot 32 is in motion, traveling between locations on airfield 12 to protect against collisions with other vehicles such as the aircraft 14, service vehicles 24, and the like. Computing system 52 can optionally deactivate the high-visibility alert during an inspection, dedicating the LED or other type of light 60 for illuminating objects under inspection.

A navigation system provided to robot 32 defines a route to be traveled by robot 32 to reach a service location where robot 32 is to inspect aircraft 14, inspect a region of airfield 12 for potential hazards, or perform some other form of inspection. The route can be defined by at least one of: i) the waypoints in the positioning system, ii) markings on airfield 12, iii) instructions transmitted to robot 32 from control center 34, iv) data obtained from navigation satellites in space or from sub-orbital or terrestrial transmitters, v) proximity data captured by sensor 46, and vi) any other source of guidance data. For example, robot 32 can include a global navigation satellite module 62 (GPS module 62) including a sensor such as a real-time kinematic sensor. GPS module 62 determines accurate location data (latitude, longitude, and altitude) by receiving signals from a plurality of satellites. These satellites transmit their position and the time the signal was sent.

GPS module 62 calculates its position by comparing the time it takes for the signals from each satellite to reach GPS module 62 and then communicates its position to (airport) computing system 36. Computing system 36 operated by control center 32 (or other suitable terminal) can transmit a destination to computing system 52 of robot 32 which, in turn, utilizes the GPS module 62 to map a defined route to the destination. Control system 52 of robot 32 controls operation of mobility system 38 based on feedback from GPS module 62 to transport robot 32 along the defined route to that destination. A “defined” route is generated by computing system 52 of robot 32 based on a current location of robot 32 when the command is received, and calculated as the optimal path in real-time when the command is received to reach the destination. The defined route can include following portions of markings appearing on airfield 12, but can optionally also include following direct paths that are not defined by markings on airfield 12, when appropriate and possible without entering into restricted regions of airfield 12 that could interrupt ground operations. Accordingly, robot 32 can be an autonomous mobile robot that calculates and follows an optimal path real-time, while adapting to a dynamic environment, rather than limited to following a fixed, existing path defined entirely by markings on airfield 14.

As another example, the navigation system can include an inertial measurement unit 64 (IMU 64) that measures and reports specific forces imparted on robot 32, angular velocities of components of robot 32, and optionally a magnetic field in the vicinity of robot 32. IMU 64 can include a plurality of sensors to track motion and orientation. More specifically, IMU 64 can include an accelerometer that measures linear acceleration forces along each axis in a three-dimensional coordinate system (e.g., X, Y, and Z axes). These forces can be attributable to movement of robot 32 to determine linear motion relative to the surface of airfield 12.

A gyroscope can also be included to measure the angular velocity of portions of robot 32 around the X, Y, and/or Z axes to track changes in angular orientation of robot 32 about those axes and detect rotational movements for determining robot 32's orientation (e.g., directional heading) in 3D space. The gyroscope detects the rate of the rotation, allowing computing system 52 to determine changes to the heading of robot 32 based on the duration of such rotation. Based on the sensed linear acceleration forces along the axes and the extent of rotation about the axes, IMU 64 can track the travel direction and turns made by robot 32 along the defined route.

According to some embodiments, the navigation system can include an optical sensor such as camera 54, when not otherwise in use, trained on the surface of airfield 12. Such a camera 54 can capture images of guide markers 30 encountered by robot 32 traveling to the desired destination. Computing system 52 of robot 32 can process the images of guide markers 30 and, in response, control operation of mobility system 38 to cause robot 32 to travel a direction corresponding to the instruction conveyed by guide markers 30.

While robot 32 is underway under the control of the navigation system, sensor 46 can be operated by control system 52 to monitor for obstacles that pose a collision risk along the defined route. In response to sensing the presence of such an obstacle, control system 52 can control mobility system 38 and thereby bring robot 32 to a stop, change the defined path to navigate robot 32 around the obstacle, or take other precautions to mitigate the potential for a collision between robot 32 and the obstacle.

Robot 32 can include an indication system such as display device 66. Embodiments of display device 66 include, but are not limited to, an LED computer screen within a weather-resistant protective case, an array of LED indicator lights, an individual LED or other light source, or any suitable display controlled by computing system 52 of robot 32. Display device 66 can be illuminated under the control of computing system 52 to convey information such as the presence of a potential hazard to aircraft 14, inspection information indicative of robot 32's inspection of aircraft 14, maintenance information regarding aircraft 14, security information about personnel authorized to access airfield 12, and the like.

Information conveyed by display device 66 can optionally be transmitted as representative data by transceiver 68 including an antenna circuit, represented in FIG. 2A as an upright protruding upward from chassis 44. Transceiver 68 can include transmitter, receiver, or both transmitter and receiver circuitry operatively connected to computing system 52 of robot 32, to facilitate wireless communications with computing system 36 of control center 34 and/or any other remote terminal. For example, transceiver 68 can transmit data indicative of actual or potential damage to aircraft 14 that has been detected (during an inspection) to computing system 36 of control center 34 for inclusion in a log entry that is specific to aircraft 14 within an aircraft database. By recording such inspection information in an aircraft database, future inspections of that aircraft 14 can account for any structural repairs or other changes that were properly made during a previous repair of the aircraft 14, but do not constitute damage that would potentially pose a hazard to the aircraft 14. In other words, future inspections of aircraft 14 by robot 32 that may otherwise flag such changes as potentially being hazardous and requiring the intervention of maintenance personnel, can be automatically recognized as being acceptable (i.e., do not pose a potential hazard warranting an alert or manual intervention to repair), thereby avoiding unnecessary alerts that would trigger manual intervention.

As another example, computing system 36 can optionally include a ground maintenance database. Transceiver 68 can be used to transmit data indicative of a location where foreign-object debris is found on airfield 12 for inclusion in a log entry in the ground maintenance database. Log entries in the ground maintenance database can be used to identify known regions of airfield 12 that are susceptible to damage, are high-traffic regions known to commonly include foreign-object debris, and/or are locations where repairs were previously performed and should be monitored for deterioration.

FIG. 2B shows an alternate embodiment of robot 32, configured for detecting foreign-object debris present on airfield 12 and/or inspecting markings applied to airfield 12. As discussed above, foreign object debris can include, but is not limited to ferromagnetic and/or non-magnetic objects on airfield 12 such as oil other fluid puddle (e.g., fluid leak from aircraft 14 or a spill of some sort); a crack, pothole or other defect in the substantially planar surface of airfield 12; a component separated from aircraft 14 or another vehicle; etc.

As shown in FIG. 2B, the alternate embodiment of robot 32 includes mobility system 38 with wheels 40 driven by electric motor(s) 42 under the control of onboard computing system 52 disposed within chassis 44. LED lights 60, for example, illuminate a portion of airfield 12 under inspection for foreign-object debris to allow for optical images of foreign-object debris to be captured by camera(s) 54 even in low-light environments and at night. Similarly, sensor 46 can include a LiDAR sensor that calculates the time required for reflected laser light from laser light source 48 to return to photodetector 50 or other light sensor.

Unlike the embodiment of robot 32 appearing in FIG. 2A, the present embodiment can be configured for a specific task, optionally eliminating one or more components possessed by the embodiment of robot 32 in FIG. 2A, or substituting a less-feature-rich component to minimize the complexity and cost of robot 32. For example display device 66 of the embodiment in FIG. 2A can optionally be replaced by display device 66 in the form of an LED light bar or other light source as shown in FIG. 2B. Responsive to detecting foreign-object debris on airfield 12, computing system 52 can control operation of display device 66 to flash, emit a defined color of light, or otherwise transmit a visible signal indicative of the presence of foreign-object debris. Additionally, or instead of operating display device 66, system 52 can optionally transmit a signal to computing system 36 of control center 34, triggering a response by ground personnel 27 via smart watch 25 or other portable communication terminal.

As another example, robot 32 of FIG. 2B can optionally include magnet 70 that magnetically attracts ferromagnetic foreign-object debris, or can be devoid of magnet 70. Embodiments including magnet 70 can operate in a manner analogous to robot 32 of the embodiment of FIG. 2A. Embodiments without magnet 70 can detect the presence of foreign-object debris, control operation of an optional vacuum, rotary brush, or other collection device, for example, activate display device 66, and/or transmit a communication with computing system 36 as notification of the presence of foreign-object debris on airfield 12.

According to some embodiments, computing system 52 can optionally analyze foreign-object debris detected on airfield 12 in an effort to determine the nature and/or size of the foreign-object debris. For example, computing system 52 can detect a size of detected foreign-object debris and attempt to collect it if the foreign-object debris is not too large, or if it is not of a nature that can't be collected (e.g., a crack in the pavement of airfield 12). As another example, computing system may sense that magnet 70 has collected the foreign-object debris detected on airfield 12, and can continue executing its search for foreign object debris. But if computing system 52 determines that the foreign-object debris is not collected by magnet 70 or other collection system, or is of a nature that is not capable of collection, robot 32 can optionally issue an alert via the display device 66 and/or transmit data to computing system 36 of control center 34 requesting intervention by ground personnel 27.

Navigation system of robot 32 in FIG. 2B can include IMU 64 that measures and reports specific forces imparted on robot 32, angular velocities of components of robot 32, and optionally a magnetic field in the vicinity of robot 32. IMU 64 can include a plurality of sensors to track motion and orientation. Ultrasonic, capacitive, or any other type of proximity sensor 65 can optionally be provided to robot 32 as an added defense against collisions with objects on airfield 12. For example, proximity sensor 65 can optionally emit an ultrasonic signal and sense reflected portions of that ultrasonic signal to detect the presence of an object in close proximity to robot 32.

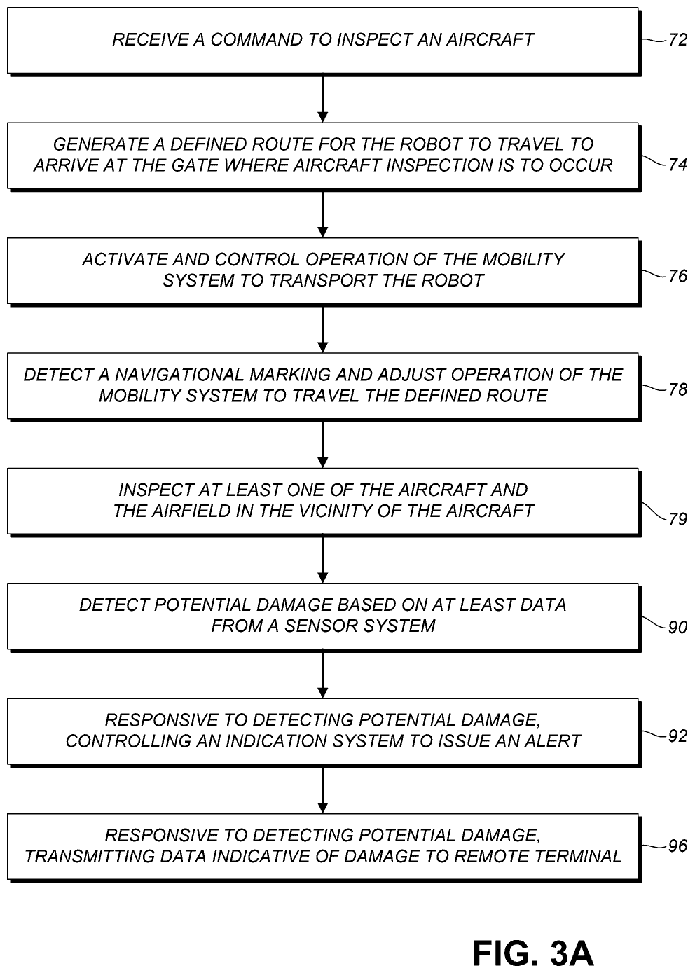

A process of inspecting aircraft 14 and/or a region of airfield 12 with autonomous robot 32 is described with reference to the flow diagram of FIG. 3A. In use, computing system 52 of robot 32 can be in constant, intermittent, or periodic communication with computing system 36 of control center 34, as needed, over a wireless communication channel via transceiver 68. For example, computing system 52 of robot 32 can receive commands, i.e., detailed operations to be performed by robot 32, the scheduled time such commands are to be performed, designated locations for each command, and the like. For the sake of clarity and brevity of describing operation of robot 32, a method of inspecting aircraft 14, and a region of airfield 12 where aircraft 14 is parked will be described with reference to the flow diagram of FIG. 3A.

A command to inspect aircraft 14 parked at gate G3 (FIG. 1) can be received via transceiver 68 at process 72 in FIG. 3A. The command can be transmitted by computing system 36 of control center 34 based on flight schedule information maintained for arriving and departing flights by airport 10, or can otherwise programmed into computing system 52 as a set schedule (e.g., inspect aircraft between certain hours). Examples of flight schedule information include, but are not limited to, at least one of: i) the arrival time of the aircraft 14, ii) gate information identifying the gate location where robot 32 is to be deployed to perform its operations, iii) the make and/or model of aircraft 14 (e.g., a Boeing 737-800), iv) a tail number or other unique aircraft identifier, v) a list of the operations to be performed, vi) the identity of ground personnel 27 on duty at the gate, vii) and any other information pertinent to the functions of robot 32 during this inspection.

A command to search for, detect and/or remove foreign-object debris can similarly be received via transceiver 68. For example, foreign-object debris instructions can include at least one of: an on-demand inspection command, and a regular inspection command. On demand inspection commands can be issued via the computing system 36 or ground personal 27 via a mobile terminal such as smart watch 25, for example, in response to the occurrence of a triggering event. By way of example, if a collision occurs between aircraft 14 and another object on airfield 12, or between a service vehicle and another object on airfield 12, ground personnel 27 or other airport staff can transmit the foreign-object debris command to computing system 52 of robot 32, along with a location where the search for foreign-object debris is to occur. According to another example, ground personnel 27 or other airport staff can program a fixed foreign-object debris search schedule into the computing system 52. By way of example, robot 32 can be scheduled to clean certain regions of airfield 12 on a defined schedule. As a specific example, robot 32 can be configured to conduct a search for foreign-object debris every night at 2:30 AM local time, or other time after normal ground operations have ceased. As another specific, robot 32 can be scheduled to search for foreign-object debris at a gate (e.g., G3) before aircraft 14 is scheduled to arrive at that gate. Such an example is coordinated with flight information pertaining to inbound and outbound flights.

At process 74, computing system 52 can generate a defined route to be traveled by robot 32 to reach the gate, which is gate G3 (FIG. 1) in the present example, where aircraft 14 to be inspected is located, or will be located upon taxiing from runway 16. To generate the defined route, computing system 52 can communicate with GPS module 62 or other positioning device to determine a current location of robot 32 relative to gate G3, and plot a course based on the relative location data.

With the defined route established, computing system 52 can activate and control operation of the mobility system at process 76. According to the present embodiment, computing system 52 can activate one or a plurality of electric motors 42 to drive wheels 40. While underway, computing system 52 can use camera 54 or other sensor to detect, at process 78, one or more navigational markings such as lines or other roadway markings on service road 22, taxi line 26 for gate G3 (FIG. 1), markings on the runway 16, virtual waypoints used by GPS module 62, or any other reference points so robot 32 can follow the defined route to aircraft 14.

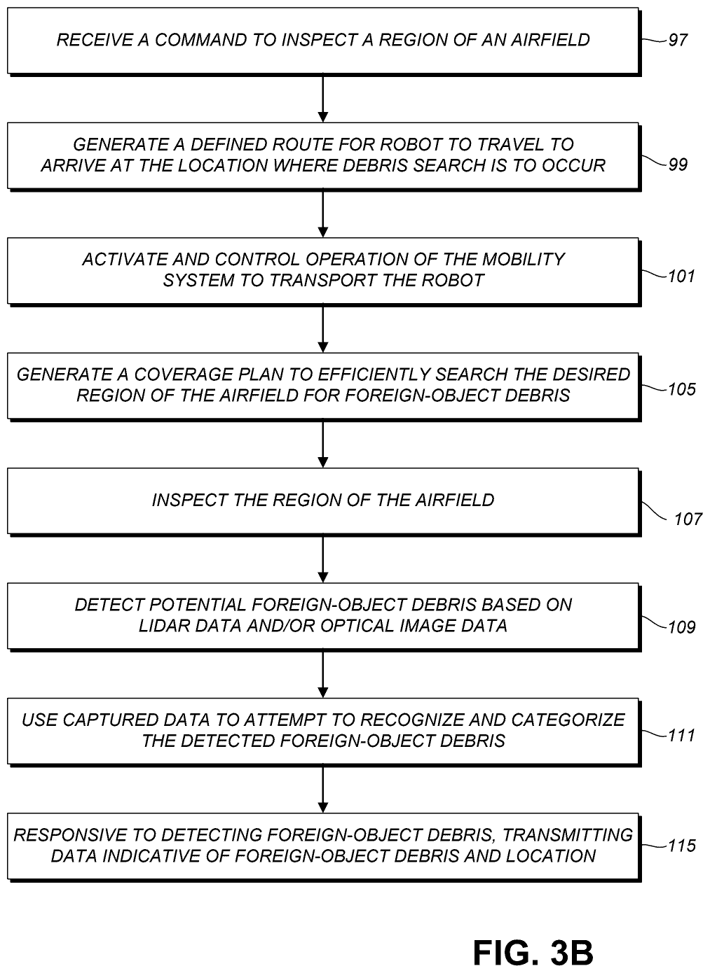

Upon arriving at gate G3 (FIG. 1), computing system 52 can commence a search for foreign-object debris, inspection of aircraft 14, or other procedure at process 79, for example, optionally magnetically collecting ferromagnetic debris with magnet 70 as robot 32 travels. As shown in FIG. 4, a region of airfield 12 at gate G3 where aircraft 14 is parked can include guide markers 30 defining an inspection path about aircraft 14. Computing system 52 can control operation of mobility system 38 to cause robot 32 to perform an inspection while traveling the entire distance of the inspection path, thereby inspecting the entirety of aircraft 14. According to alternate embodiments, the inspection path can be determined in real time by computing system 52. For example, the computing system 52 of such embodiments can use the data generated by proximity sensor 46 to detect the presence of aircraft 14, and control operation of mobility system 38 to transport robot 32 about the entire perimeter of aircraft 14.

According to other embodiments, the command received by transceiver 68 can be executed over a region of airfield 12 defined as part of the command. For example, robot 32 can be given a specific area of airfield 12 to cover while searching for foreign-object debris. Computing system 52 of robot 32 can execute a coverage planning process, during which computing system 52 generates a map of a path for robot 32 to travel to inspect the specified area of airfield 12 for foreign-object debris. According to such embodiments, robot 32 does not follow a fixed, predefined route every time a search for foreign-object debris is to be conducted as the same region of airfield 12. Instead, robot 32 can travel an adaptive route, which is specific to region of airfield 12 to be inspected for foreign-object debris by robot 32 based on different geography or shapes of the area for each search, markings on the area for each search or other procedure. Such an embodiment can be considered an autonomous mobile robot, rather than an autonomous guided vehicle that is programmed with a fixed path at a destination and travels that exact path each time without adapting consideration of the region of airfield 12 to be searched, potential obstacles thereon, geography of the airport, etc. An adaptive route can also be beneficial during operations involving a plurality of robots 32. Each robot 32 involved can optionally be assigned to a different area of airfield 12, and each robot 32 generates its travel path at that time by performing coverage planning based on the assigned task. Computing system 36 can optionally coordinate such operations to make efficient use of robots 32 and therefore minimize overlap of inspection regions, which can prevent each robot 32 from detecting and considering another robot as foreign-object debris or other obstacle that requires resolution by ground personnel 27.

Robot 32 can utilize geography of airport 10 on airfield 12, in addition to or instead of its navigation system to navigate to a region to execute the command received by transceiver 68, and/or navigate during execution of the command. For example, one or more sensors provided to robot 32 can be used by computing system 52 to detect obstacles en route to, or at the location where the command is to be executed. As a specific example, camera(s) 54 can optically detect nearby obstacles, and detect markings such as taxi lines 26 or guide markers 30 on airfield 12. Sensor 46 and/or proximity sensor 65 can detect the presence of a fixed (e.g., perimeter fence, building, etc.) or mobile (e.g., service vehicle 24, aircraft 14, jet bridge 28) obstacle present along the travel path leading to the location where the command is to be executed, or the travel path of robot 32 during execution of the command at the specific destination.

The inspection can involve using proximity sensor 46 to detect the presence of aircraft 14 at the gate G3 (FIG. 1), and to create a monochromatic representation of the surface of airfield 12 and the exterior surface of aircraft 14. The monochromatic representations can be useful to detect dents and other such contours in the surface of airfield 12 and/or surface of aircraft 14′s fuselage that may be difficult to detect using an optical image-capture method.

According to some embodiments, computing system 52 can optionally use another portion of damage sensor system 58, such as camera 54 for example, to capture images of airfield 12 and/or exterior surface of aircraft 14. The captured images can be processed by computing system 52, optionally overlayed on the monochromatic representations of airfield 12 and/or exterior surface of aircraft 14, respectively, to detect foreign-object debris on airfield 12 and/or potential damage to aircraft 14.

For example, computing system 52 can execute optical inspection instructions that compare the captured images to reference images of corresponding portions of aircraft 14 that are known to be free of damage and defects. Negligible differences between the captured images and the reference images that may reflect expected wear and tear are not considered safety critical can be deemed to be acceptable, avoiding the issuance of an alert to ground personnel 27 or other airport personnel. However, the detection of substantial differences can trigger an alert by display device 66 of the indication system in response to the potential damage being detected by computing system 52.

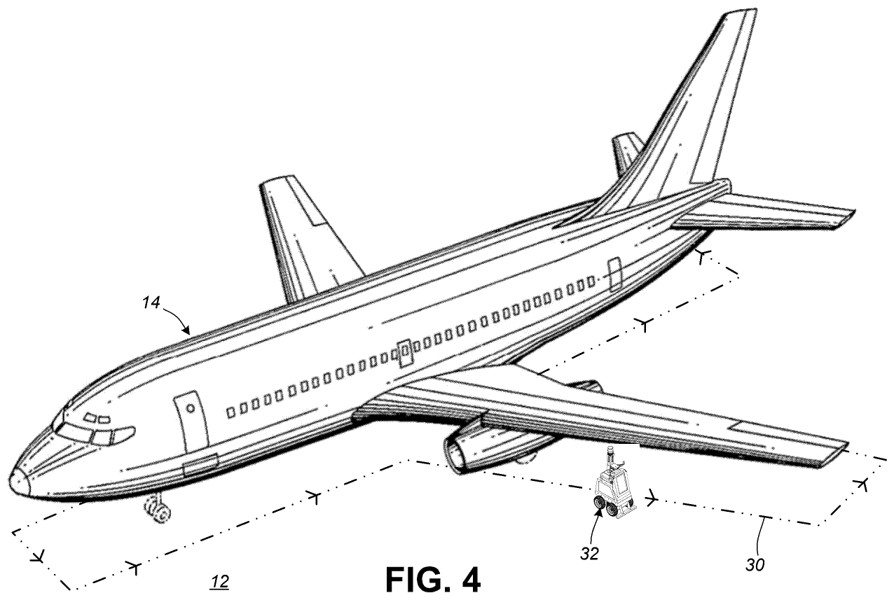

FIG. 5A shows a schematic representation of a reference section of the surface of aircraft 14, that is known to be free of defects and damage. The portion of aircraft 14 appearing in FIG. 5A includes body panels 75 properly secured in place with their full allocation of rivets 77 called for by design. FIG. 5B, on the other hand, shows a schematic representation of a corresponding section of the surface of aircraft 14 in an image captured by the damage sensor system 58. The computing system's comparison of the captured image of FIG. 5B to the reference image of FIG. 5A reveals potential damage that appears in the captured image that is not present in the reference image. The following potential damage appears in the captured image: a damaged or missing rivet 80, a body panel deformity 82 causing a gap 84 to form next to the undamaged edge 86 of a neighboring body panel, and a fluid 88 such as hydraulic fluid that appears to be leaking from gap 84.

Referring once again to FIG. 3A, in response to detecting the potential damage at process 90, computing system 52 can control display device 66 of the indication system to issue an alert at process 92. Computing system 52 can optionally also control mobility system 38 to stop robot 32 at the location where the potential damage was detected. The alert can include a graphical display including an image of the portion of the fuselage that triggered the alert, optionally with a circle or other shape, or highlighting to identify where the potential damage can be found. The graphical display can optionally include text that describes the nature of the potential damage, remedial action that can be taken to address the potential damage, the location of the potential damage, or any other information related to the potential damage. According to some embodiments, robot 32 can optionally include a laser or other light projection source to illuminate the actual portion of aircraft 14 where the potential damage was detected.

Such optical inspection instructions can optionally be executed in combination with generative artificial intelligence instructions (“AI engine”). The AI engine, when executed, modifies the optical inspection instructions to reflect changes that have been manually identified as constituting/not constituting damage. For example, ground personnel 27 may input confirmation via a touchscreen embodiment of the display device 66 that potential damage in the captured image is, in fact, damage requiring repairs. Prior to accepting such input, however, camera 54 can optionally capture an image of the face of the ground personnel 27 for facial recognition or execute a code-scanner function that reads a barcode/magnetic strip/other computer-readable code on a security badge worn by ground personnel 27. According to alternate embodiments, camera 54 can routinely conduct facial recognition or other identification confirmation processes to detect any unauthorized personnel on airfield 12. The optical inspection instructions related to the reference image for that portion of aircraft 14 can be automatically modified by the AI engine to reflect this confirmation.

The above embodiment of the AI engine is a trained model, modifying the optical inspection instructions in response to known data concerning damage. However, according to alternate embodiments, the AI engine can be an untrained model, which starts with present values and does not modify the optical inspection instructions based on a training data set. Such an “untrained” model can optionally suggest modifications to the optical inspection instructions after the optical inspection instructions identify a statistically-significant number of common forms of damage.

At process 96, transceiver 68 transmits data indicative of the potential damage detected to a remote terminal such as computing system 36 of control center 34, for example. According to some embodiments, transceiver 68 can transmit the data indicative of the potential damage to a smart watch 25, tablet computer, smart phone, etc. that is accessible by ground personnel 27, to alert the ground personnel 27 to the potential damage and request manual inspection. The potential damage detected during an inspection may be a previous repair made to aircraft 14, to fix damage detected during a previous inspection.

For example, in FIG. 5B metal patch 94 is shown installed on a fuselage panel where a crack or other type of damage was previously detected and repaired. The optical inspection instructions executed by computing system 52 may detect patch 94 based on the captured image of that portion of aircraft 14. Ground personnel 27 can input confirmation that patch 94 does not constitute actual damage into a touch-sensitive embodiment of display device 66 and, in response, computing system 52 transmits this data point via transceiver 68 to computing system 36 of control center 34. Computing system 36 of control center 34 updates the database to include a log entry specific to this particular aircraft 14 (e.g., uniquely identified by tail number), including information identifying patch 94 as not constituting actual damage. Accordingly, during future inspections of this particular aircraft 14, robot 32 will identify aircraft 14 and access the database to retrieve the log entry. The log entry can optionally identify the location of patch 94, causing computing system 52 of robot 32 to operate the mobility system 38 to transport robot 32 to a location near patch 94 suitable for inspection based on guide markers 30, proximity data, navigational data, or any combination thereof. Robot 32 can inspect the portion of aircraft 14 with patch 94 for any deviations from an earlier captured image of patch 94. Thus, robot 32 can routinely monitor the integrity of patch 94 over time and can thereby avoid flagging patch 94 as potential damage during subsequent inspections unless a current image of patch 94 deviates from a historical image in the database.

An illustrative embodiment of a process of inspecting a marking on airfield 12 is described with reference to FIG. 3B. Similar to the process of inspecting aircraft 14 described above, a command to search for, detect and/or remove foreign-object debris from airfield 12 can be received via transceiver 68 at process 97. For example, foreign-object debris instructions can include at least one of: an on-demand inspection command, and a regular inspection command. On demand inspection commands can be issued via the computing system 36 or ground personal 27 via a mobile terminal such as smart watch 25, for example, in response to the occurrence of a triggering event. By way of example, if a collision occurs between aircraft 14 and another object on airfield 12, or between service vehicle 24 and another object on airfield 12, ground personnel 27 can transmit the foreign-object debris command to computing system 52 of robot 32, along with a location where the search for foreign-object debris is to occur. According to another example, ground personnel 27 or other airport staff can program a fixed foreign-object debris search schedule into the computing system 52. By way of example, robot 32 can be scheduled to clean certain regions of airfield 12 on a defined schedule. As a specific example, robot 32 can be configured to conduct a search for foreign-object debris every night at 2:30 AM local time, or other time after normal ground operations have ceased. As another specific, robot 32 can be scheduled to search for foreign-object debris at a gate (e.g., G3) before aircraft 14 is scheduled to arrive at that gate. Such an example is coordinated with flight information pertaining to inbound and outbound flights.

At process 99, computing system 52 can generate a defined route to the location where robot 32 is to search for foreign-object debris. To generate the defined route, computing system 52 can communicate with GPS module 62 or other positioning device to determine a current location of robot 32 relative to the location on apron 18, and plot a course based on the relative location data. Again, the defined route is adaptive based on conditions when the command is received at process 97, and can be calculated as an ideal route to follow at that time regardless of whether markings are present on airfield 12 at any point along the ideal route.

With the defined route established, computing system 52 can activate and control operation of mobility system 38 at process 101 in a manner similar to that described above.

Computing system 52 can generate a coverage plan at process 105. The coverage plan can be an adaptive route specific to the region of airfield 12 to be inspected for foreign-object debris, and is generated based on at least one of: the geography of the region of the airfield 12, markings on the region of the airfield 12 to be searched, LiDAR data captured of adjacent buildings and structures, etc., and commences the search at process 107. Thus, robot 32 determines a route to be traveled while actively searching for the foreign-object debris, and adapts as necessary upon encountering any obstacles detected while searching.

According to such embodiments, robot 32 does not follow a fixed, predefined route every time a search for foreign-object debris is to be conducted at the same region of airfield 12. Instead, robot 32 can travel an adaptive route, which is specific to region of airfield 12 to be inspected for foreign-object debris by robot 32 based on different geography or shapes of the area for each search, markings on the area for each search or other procedure. Again, such an embodiment can be considered an autonomous mobile robot, rather than an autonomous guided vehicle that is programmed with a fixed path at a destination and travels that exact path each time without adapting consideration of the region of airfield 12 to be searched, potential obstacles thereon, geography of the airport, etc.

During the search the LiDAR and/or camera 54 can capture data indicative of foreign-object debris on airfield 12 at process 109. The monochromatic representations based on LiDAR data can be useful to detect a shape of the foreign-object debris, while camera 54 can also capture shape data related to the foreign-object debris. Camera 54 can also capture color data indicative of a color of the potential foreign-object debris detected on airfield 12.

At process 111, data indicative of the shape and color can be compared by computing system 52 executing optical inspection algorithms to reference images stored in a database accessible to computing system 52 in an attempt to recognize and categorize the detected foreign-object debris. The reference images can include images of known objects commonly found on airfield 12, optionally rotated to a plurality of different orientations. Matches of shapes and colors to known foreign-object debris in the database can be used to improved or further train the optical inspection algorithms for future comparisons. In the event a shape is not recognized, a matching color can be used alone to categorize the detected foreign-object debris into a general category based on the type of material of the foreign-object debris. This categorization and optional identification can be transmitted along with location data at process 115 to a remote terminal such as computing system 36, for example. The location of the detected foreign-object debris can be transmitted to smart watch 25 or another portable device worn by ground personnel 27 for manual removal of the detected foreign-object debris.

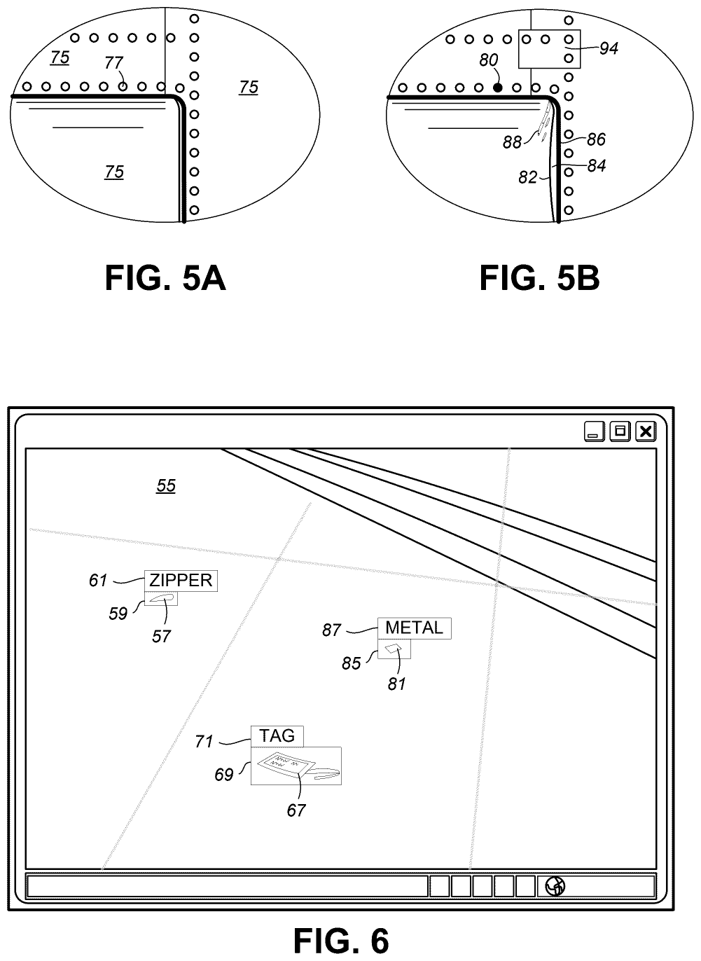

The remote terminal 36 can optionally generate a graphical representation 55 such as that shown in FIG. 6, for example, showing images of the detected foreign-object debris labeled by computing system 52, computing system 36, or another computing system. Graphical representation can be displayed by a computer monitor or other display along with identification information, if available. In the illustrative example shown, zipper 57 from a piece of luggage, for example, has been positively identified as being present on airfield 14. Zipper 57 can be highlighted by virtual rectangle 59. The positive identification by computing system 52 is designated by label 61 describing the specific type of foreign-object debris identified. Similarly, a luggage tag 67 has been positively identified and enclosed by rectangle 69, and designated by label 71 describing the detected foreign-object debris.

When a positive identification is not able to be made, but a color of the detected foreign-object debris has been detected, a general identification of the material or other classification of the foreign-object debris can be generated and transmitted to computing system at process 115. Again, this information can be included in the virtual representation 55. For example, an unidentifiable object 81 can be highlighted by virtual rectangle 85. Since a positive identification was not made by computing system 52, label 87 can be included in the virtual representation 55, but label 87 identifies “METAL” as the category to which the unidentifiable object 81 belongs based on the detected color of that unidentifiable object 81.

FIG. 7 shows a schematic representation of computing device 98 as embodiments of computing systems 36, 52 configured with at least one of: i) the optical inspection instructions, ii) the AI engine, iii) the database, and iv) other computer-executable instructions according to the processes herein. The exemplary computing device 98 may be a computer that includes processor 100, memory 102, and input/output ports 104 operably connected by bus 106. In one example, computing device 98 may include logic 108 configured to control operation of at least one of: i) mobility system 38, ii) electric motor 42, iii) sensors 46, iv) laser light source 48, v) photodetector 50, vi) camera 54, vii) adjustable mount 56, viii) damage sensor system 58, ix) light 60, x) GPS module 62, xi) IMU 64, xii) display device 66, xiii) transceiver 68, and xiv) magnet 70. In different examples, logic 108 may be implemented in hardware, a non-transitory computer-readable medium with stored instructions, firmware, and/or combinations thereof. While logic 108 is illustrated as a hardware component attached to bus 106, it is to be appreciated that in other embodiments, logic 108 could be implemented in processor 100, stored in memory 102, or stored in disk 110.

In one embodiment, logic 108 or computing device 98 is a means (e.g., structure: hardware, non-transitory computer-readable medium, firmware) for performing the actions described. In some embodiments, computing device 98 may be a server operating in a cloud computing system, a server configured in a Software as a Service (SaaS) architecture, a smartphone, laptop, tablet computing device, and so on.

The means may be implemented, for example, as an ASIC (application-specific integrated circuit) programmed to perform the processes described herein. The means may also be implemented as stored computer executable instructions that are presented to computing device 98 as data 112 that are temporarily stored in memory 102 and then executed by processor 100.

Logic 108 may also provide means (e.g., hardware, non-transitory computer-readable medium that stores executable instructions, firmware) for performing the operations regarding the processes described herein.

Generally describing an illustrative configuration of computing device 98, processor 100 may be a variety of various processors including dual microprocessor and other multi-processor architectures. Memory 102 may include volatile memory and/or non-volatile memory. Non-volatile memory may include, for example, ROM, PROM, and so on. Volatile memory may include, for example, RAM, SRAM, DRAM, and so on.

Storage disk 110 may be operably connected to computing device 98 via, for example, input/output (I/O) interface (e.g., card, device) 104 and input/output port 104. Disk 110 may be, for example, a magnetic disk drive, a solid-state disk drive, a floppy disk drive, a tape drive, a Zip drive, a flash memory card, a memory stick, and so on. Furthermore, disk 110 may be a CD-ROM drive, a CD-R drive, a CD-RW drive, a DVD-ROM, and so on. Memory 102 can store a process 116 and/or a data 112, for example. Disk 110 and/or memory 102 can store an operating system that controls and allocates resources of computing device 98.

Computing device 98 may interact with input/output (I/O) devices via I/O interfaces 114 and input/output ports 104. Input/output devices may be, for example, a keyboard, a microphone, a pointing and selection device, cameras, video cards, displays, disk 110, network devices 118, and so on. Input/output ports 104 may include, for example, serial ports, parallel ports, and USB ports.

Computing device 98 can operate in a network environment and thus may be connected to the network devices 118 via I/O interfaces 114, and/or I/O ports 104. Through network devices 118, computing device 98 may interact with a network. Through the network, computing device 98 may be logically connected to remote computers. Networks with which the computing device 98 may interact include, but are not limited to, a LAN, a WAN, and other networks.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks.

The following section's content includes definitions of selected terms employed herein. These definitions include various examples and/or forms of components that fall within the scope of a term and that may be used for implementation. These examples are not intended to be limiting. Both singular and plural forms of terms may be included within these definitions.

References to “one embodiment,” “an embodiment,” “one example,” “an example,” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Computer-readable medium” or “computer storage medium,” as used herein, refers to a non-transitory medium that stores instructions and/or data configured to perform one or more of the disclosed functions when executed by at least a single processor. Data may function as instructions in some embodiments. A computer-readable medium may take forms, including, but not limited to, non-volatile media or volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read-only memory (ROM), a memory chip or card, a memory stick, solid-state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions.

“Logic,” as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a goal, then hardware would be selected to implement functions. If a lower cost is desired, then stored instructions/executable application would be selected to implement the functions.

Illustrative embodiments have been described, hereinabove. It will be apparent to those skilled in the art that the above devices and methods may incorporate changes and modifications without departing from the general scope of this invention. It is intended to include all such modifications and alterations within the scope of the present invention. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An apparatus for searching for foreign-object debris on an airfield of an airport, the airfield comprising a runway where an aircraft takes off and lands, an apron where the aircraft parks between landing and taking off, and a taxiway that can be used by the aircraft to travel between the runway and the apron, the apparatus comprising:
a receiver that receives a command to conduct a search for foreign-object debris on a region of the airfield comprising at least one of the apron and the runway, wherein the command identifies the region of the airfield to be searched for the foreign-object debris;
a navigation system that: (i) generates a route to be traveled by the apparatus to reach the region of the airfield identified in the command received by the receiver, and (ii) generates a coverage plan that defines a travel path to be traveled by the apparatus over the region of the airfield to conduct the search for the foreign-object debris;
a mobility system that is operable to transport the apparatus along the route to the region of the airfield, and to transport the apparatus along the travel path during a search for the foreign-object debris;
sensor circuitry that detects: (i) an obstacle on the airfield encountered by the apparatus, and (ii) the foreign-object debris on the airfield; and
a computing system comprising one or a plurality of computer processors that executes computer-executable instructions to: (i) control operation of the mobility system to avoid a collision between the apparatus and the obstacle on the airfield detected by the sensor circuitry, and (ii) identify and/or classify the foreign-object debris.

2. The apparatus of claim 1 further comprising a transmitter that transmits data indicative of a location where the foreign-object debris was found on the airfield for inclusion in a log entry of a ground maintenance database.

3. The apparatus of claim 1 further comprising a debris collector comprising a magnet that magnetically attracts ferromagnetic debris on the region of the airfield.

4. The apparatus of claim 1 further comprising a debris collector comprising at least one of a vacuum and a sweeper.

5. The apparatus of claim 1, wherein the navigation system generates the coverage plan to include an adaptive route specific to the region of the airfield to be inspected for the foreign-object debris based on an environment of the region of the airfield to be inspected based on LiDAR data.

6. The apparatus of claim 1 further comprising a display device that is controlled by the computing system to emit a visible signal in response to detection of the foreign-object debris by the sensor circuitry.

7. The apparatus of claim 1, wherein the sensor circuitry comprises a light source that emits light and a sensor that detects a reflected portion of the light emitted by the light source to detect the foreign-object debris on the airfield.

8. The apparatus of claim 1, wherein the sensor circuitry comprises a camera that captures an optical image that is analyzed by the computing system to detect the foreign-object debris on the airfield.

9. The apparatus of claim 1, wherein the computing system establishes a scheduled time to conduct the search for the foreign-object debris based in part on a flight schedule at the airport.

10. An apparatus for searching for foreign-object debris on an airfield of an airport, the airfield comprising a runway where an aircraft takes off and lands, and an apron where the aircraft parks between landing and taking off, the apparatus comprising:
a receiver that receives a command to conduct a search for foreign-object debris on a region of the airfield;
a navigation system that: (i) generates a route to be traveled by the apparatus to reach the region of the airfield, and (ii) generates a coverage plan that defines a travel path to be traveled by the apparatus over the region of the airfield to conduct the search for the foreign-object debris;
a mobility system that is operable to transport the apparatus along the route to the region of the airfield, and to transport the apparatus along the travel path during a search for the foreign-object debris;
sensor circuitry that detects: (i) an obstacle on the airfield encountered by the apparatus, and (ii) the foreign-object debris on the airfield;
a computing system comprising one or a plurality of computer processors that executes computer-executable instructions to: (i) control operation of the mobility system to avoid a collision between the apparatus and the obstacle on the airfield detected by the sensor circuitry, and (ii) identify and/or classify the foreign-object debris.; and
a display device that is controlled by the computing system to emit a visible signal in response to detection of the foreign-object debris by the sensor circuitry.

11. The apparatus of claim 10 further comprising a transmitter that transmits data indicative of a location where the foreign-object debris was found on the airfield for inclusion in a log entry of a ground maintenance database.

12. The apparatus of claim 10, wherein the navigation system generates the coverage plan to include an adaptive route specific to the region of the airfield to be inspected for the foreign-object debris based on at least one of: a geography of the region of the airfield, and markings on the region of the airfield.

13. The apparatus of claim 10, wherein the sensor circuitry comprises a light source that emits light and a sensor that detects a reflected portion of the light emitted by the light source to detect the foreign-object debris on the airfield.

14. The apparatus of claim 10, wherein the sensor circuitry comprises a camera that captures an optical image that is analyzed by the computing system to detect the foreign-object debris on the airfield.

15. The apparatus of claim 10, wherein the computing system establishes a scheduled time to conduct the search for the foreign-object debris based in part on a flight schedule at the airport.

16. An apparatus for searching for foreign-object debris on an airfield of an airport, the airfield comprising a runway where an aircraft takes off and lands, and an apron where the aircraft parks between landing and taking off, the apparatus comprising:
a receiver that receives a command to conduct a search for foreign-object debris on a region of the airfield;
a navigation system that: (i) generates a route to be traveled by the apparatus to reach the region of the airfield, and (ii) generates a coverage plan that defines a travel path to be traveled by the apparatus over the region of the airfield to conduct the search for the foreign-object debris;
a mobility system that is operable to transport the apparatus along the route to the region of the airfield, and to transport the apparatus along the travel path during a search for the foreign-object debris;
sensor circuitry that detects: (i) an obstacle on the airfield encountered by the apparatus, and (ii) the foreign-object debris on the airfield; and
a computing system comprising one or a plurality of computer processors that executes computer-executable instructions to: (i) control operation of the mobility system to avoid a collision between the apparatus and the obstacle on the airfield detected by the sensor circuitry and (ii) identify and/or classify the foreign-object debris.
